(19) United States
(12) Patent Application Publication
(10) Pub. No.: US 2016/0221174 A1
(43) Pub. Date: Aug. 4, 2016

(54) Drywall Knife And Multi-Tool Assembly

(71) Applicant: Daniel J. Raymond, Saginaw, MI (US)

(72) Inventor: Daniel J. Raymond, Saginaw, MI (US)

(21) Appl. No.: 15/012,388

(22) Filed: Feb. 1, 2016

Related U.S. Application Data
(60) Provisional application No. 62/109,739, filed on Jan. 30, 2015.

(51) Int. Cl. B25F 1/04; B25B 15/00; E04F 21/02; B26B 1/04

(52) U.S. Cl. CPC B25F 1/04; B26B 1/04; B25B 15/005; E04F 21/026

(57) ABSTRACT

The multi-tool assembly includes a handle which extends in a first direction between opposite ands and which presents an interior with a pocket. A first blade with a flat edge is secured with one end of the handle for spreading a drywall joint compound. The multi-tool assembly further includes a utility knife blade for cutting drywall sheets and a blade holder which engages the utility knife blade.

### CROSS-REFERENCE TO RELATED APPLICATION

This Patent Application claims the benefit and priority to U.S. Provisional Patent Application Ser. No. 62/109,739, filed on Jan. 30, 2015, the entire disclosure being considered a part of this application and hereby incorporated by reference.

### BACKGROUND OF THE INVENTION

1. Field of the Invention

The present invention is related to hand-held multi-tool assemblies and particularly to tools for use in the drywall industries.

2. Related Art

People who work with drywall often intermittently use a number of different tools when installing drywall panels into a room of a building. For example, workers will typically carry a utility knife for cutting the drywall panels to size and for cutting openings (for example, for outlets) into the drywall panels. Workers will also typically carry a Phillips screwdriver for screwing the drywall panels into the studs and for securing outlet and switch covers to the walls. Still further, workers usually also carry a putty knife for spreading a joint compound between adjacent drywall panels to provide a very smooth surface once the joint compound dries and is sanded to flatness.

Some workers carry a utility knife, a screwdriver and a putty knife on their belts to allow for easier switching between the three tools while on the job. Nonetheless, while a belt can make switching between the tools easier than without a belt, switching can nonetheless still be a clumsy, time consuming and potentially dangerous process if the worker fails to take proper care while handling the utility knife. Switching between the tools often also requires the worker to take his or her eyes off of the project at hand, which can further delay completion of the job at hand.

### SUMMARY OF THE INVENTION AND ADVANTAGES

One aspect of the present invention is for a multi-tool assembly for use in drywall installation and repair. The multi-tool assembly includes a handle which extends in a first direction between opposite ands and which presents an interior with a pocket. A first blade with a flat edge is secured with one end of the handle for spreading a drywall joint compound. The multi-tool assembly further includes a utility knife blade for cutting drywall sheets and a blade holder which engages the utility knife blade.

The multi-tool assembly is advantageous because it can accomplish the tasks of all three tools in one, compact tool. The multi-tool assembly also offers improved safety by safely protecting the utility knife blade within the handle when it is not in use.

According to another aspect of the present invention, the blade holder is rotatable about a pivot axis between the open and closed positions.

According to yet another aspect of the present invention, the multi-tool assembly further includes a locking mechanism for locking the blade holder in at least one of the open and closed positions.

According to still another aspect of the present invention, the locking mechanism includes at least one button that is releasably engagable with a detent in the blade holder for locking the blade in at least one of the open and closed positions.

According to a further aspect of the present invention, the locking mechanism includes a pair of buttons that are spaced from the pivot axis with one of the buttons being configured to lock the blade holder in the open position and the other button being configured to lock the blade holder in the closed position.

According to yet a further aspect of the present invention, when the blade holder is in the open position, the knife blade extends at an angle of between thirty and sixty degrees, and most preferably at an angle of approximately forty-five degrees, relative to the handle.

According to still a further aspect of the present invention, the housing has an opening for passing the knife blade into and out of the pocket of the housing.

According to another aspect of the present invention, a screwdriver bit is secured with the handle adjacent the utility knife blade.

According to yet another aspect of the present invention, a bit holder is permanently secured with the handle and which releasable receives the screwdriver bit.

According to still another aspect of the present invention, the screwdriver bit is a Phillips head screwdriver bit.

According to another aspect of the present invention, the screwdriver bit extends at an angle of between thirty and sixty degrees, and most preferably approximately forty-five degrees, relative to the handle.

Another aspect of the present invention is for a method of installing or repairing drywall. The method includes the step of providing a multi-tool assembly which includes a single handle that extends in a first direction between opposite ends and has a putty blade secured with one end and a blade holder with a utility knife blade secured with the other end. The method continues with the step of spreading a joint compound between adjacent drywall panels with the putty blade. The method proceeds with the step of moving the blade holder from a closed position with the utility knife blade being fully disposed within the handle to an open position with the utility knife blade extending partially out of the handle. The method continues with the step of cutting one of the drywall panels with the utility knife blade.

According to another aspect of the present invention, the method includes the step of securing a drywall panel to a stud with a screwdriver bit adjacent the utility knife blade.

### BRIEF DESCRIPTION OF THE DRAWINGS

These and other features and advantages of the present invention will be readily appreciated, as the same becomes better understood by reference to the following detailed description when considered in connection with the accompanying drawings wherein:

FIG. 1 front elevation view of an exemplary embodiment of a multi-tool assembly with a blade holder in an open position;

FIG. 2 is a front elevation view of the multi-tool assembly of FIG. 1 but with the blade holder in a closed position;

FIG. 3 is a side elevation view of the multi-tool assembly of FIG. 1 with the blade holder in the closed position;

FIG. 4 is a side elevation view of the multi-tool assembly of FIG. 1 with the blade holder in the open position;

FIG. 5 is a perspective view of the multi-tool assembly of FIG. 1 being used to spread a joint compound into a joint between adjacent drywall panels;

FIG. 6 is a front view of the multi-tool assembly of FIG. 1 being used to secure a light switch with a wall; and

FIG. 7 is a front view of the multi-tool assembly of FIG. 1 being used to cut a drywall panel with a utility knife blade.

### DESCRIPTION OF THE ENABLING EMBODIMENT

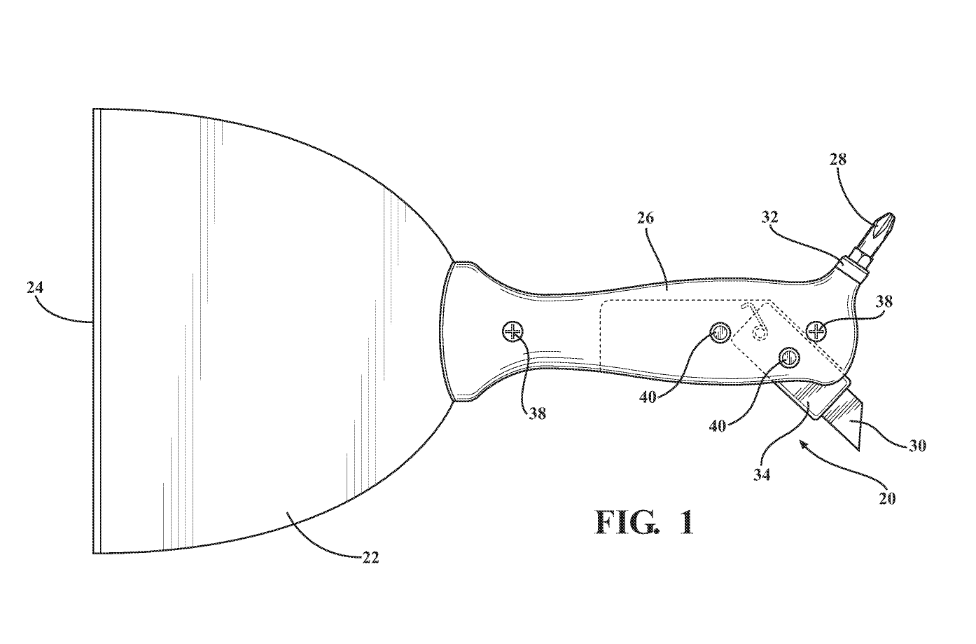

Referring to FIG. 1, wherein like numerals indicate corresponding parts throughout the several views, an exemplary embodiment of an improved drywall working multi-tool assembly 20 is generally shown in FIG. 1. As shown, the exemplary drywall working multi-tool assembly 20 includes a generally planar putty blade 22 with a flat edge 24 and a handle 26 which is joined with the putty blade 22 opposite of the flat edge 24. The putty blade 22 is preferably made of metal (such as, for example, stainless steel) or a hard plastic, and the flat edge 24 is adapted for evenly spreading a drywall joint compound onto a joint between adjacent drywall panels. The handle 26 extends from the putty blade 22 to a distal end. The handle 26 may be made of any suitable material including, for example, rubber, nylon, plastic or metal.

At the distal end of the handle 26, the exemplary drywall knife assembly 20 includes a Phillips head screwdriver bit 28 and a utility knife blade 30. As such, the multi-tool assembly 20 includes tools for rotating screws to fasten drywall panels to studs, for cutting drywall panels and for spreading a drywall joint compound in the cracks between adjacent drywall panels. This enables a drywall worker to carry just one tool rather than three separate tools when performing these three tasks.

In the exemplary embodiment, a sleeve (or a bit holder 32) with a hexagonally shaped bore is permanently (i.e., non-removably) secured with the handle, and the Phillips head screwdriver bit 28 is removably disposed in the bit holder 32, thereby allowing for quick and easy replacement of the Phillips head screwdriver bit 28 when it has become worn and for allowing differently sized Phillips head screwdriver bits or for other types of bits (e.g., regular/flat head or Torx head) to be used. Alternately, the Phillips head screwdriver bit 28 could be directly and permanently attached with the handle 26. The bit holder 32 or Phillips head screwdriver bit 28 may be permanently joined with the handle 26 through any suitable means including, for example, adhesives, welding, overmolding, brazing, material deformation, etc. In the exemplary embodiment, the Phillips head screwdriver bit 28 extends at an angle of between thirty and ninety degrees)(30-90°) relative to the handle 26 and, most preferably, at an angle of approximately forty-five degrees)(45°). Such an angled configuration allows for easier use of the Phillips head screwdriver bit 28 by allowing a user to apply increased torque to the Phillips head screwdriver bit 28 through mechanical advantage.

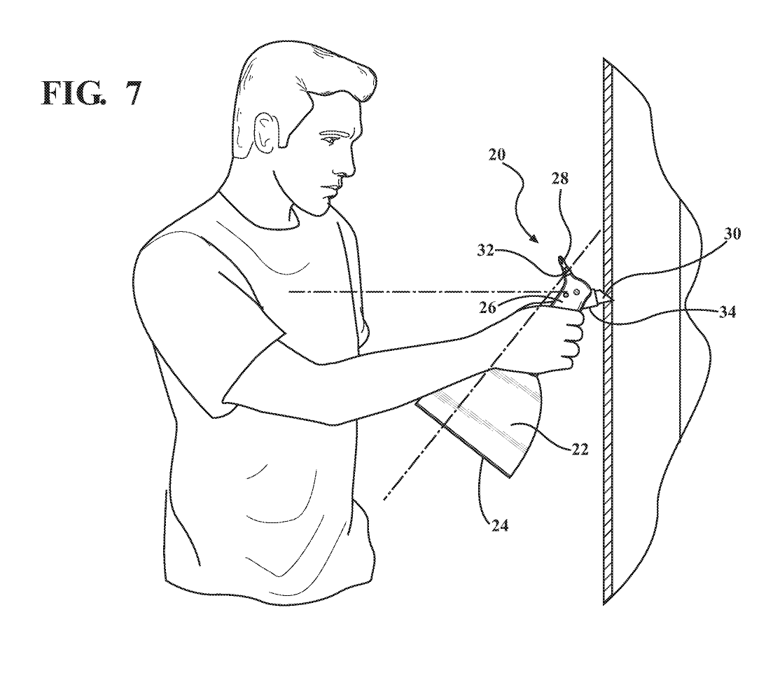

Referring still to FIG. 1, adjacent the screwdriver bit 28, the multi-tool assembly 20 is provided with a utility knife blade holder 34 that is also disposed adjacent the distal end of the handle 26 opposite of the putty blade 22. The utility knife blade 30 is secured within the blade holder 34 for cutting objects, such as drywall sheets, as shown in FIG. 7. The blade holder 34 of the exemplary embodiment is generally rectangular in shape and has a slot for receiving the knife blade 30. However, it should be appreciated that the blade holder 34 could take a range of forms and shapes for holding the knife blade 30.

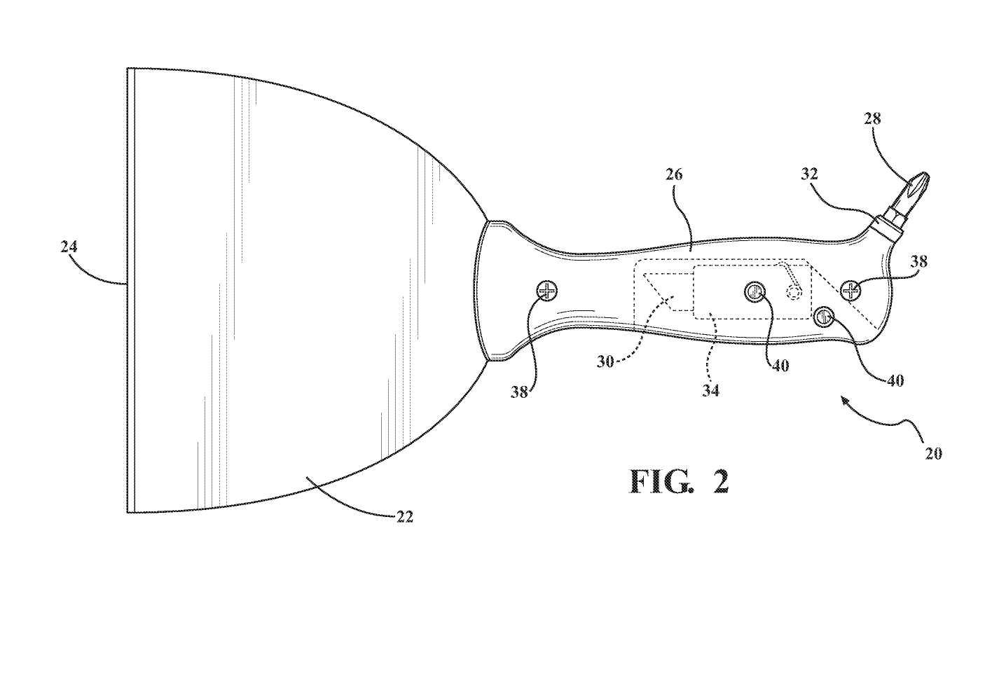

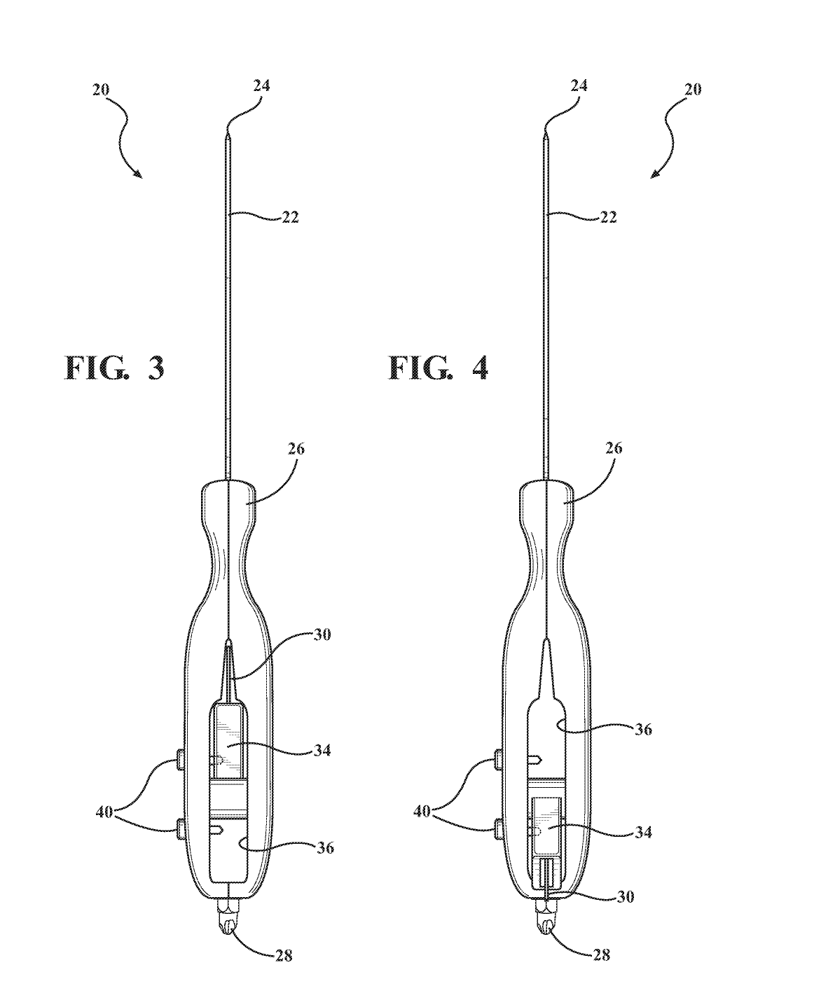

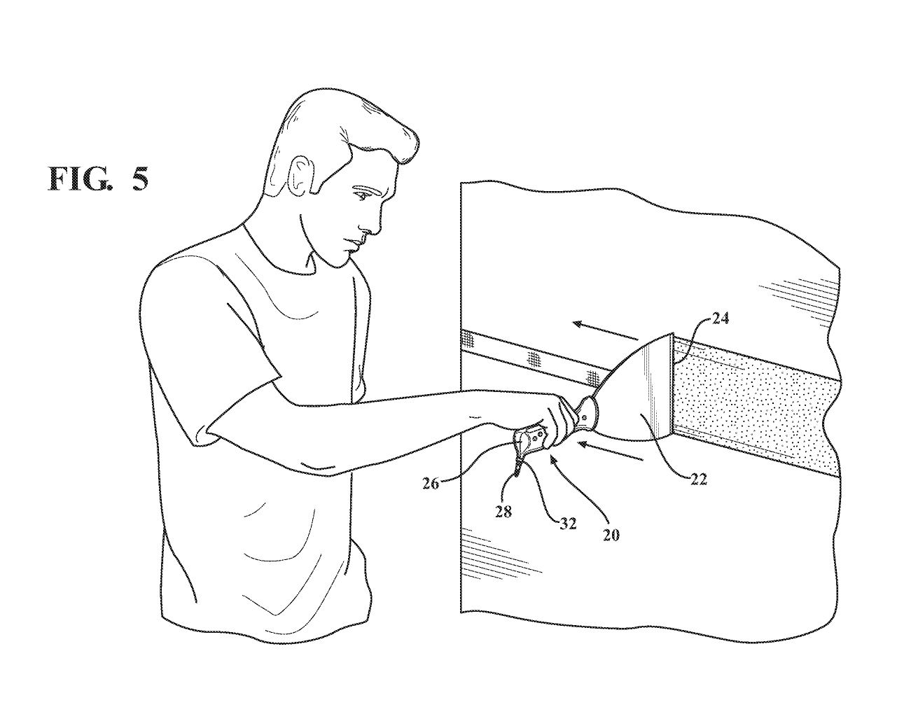

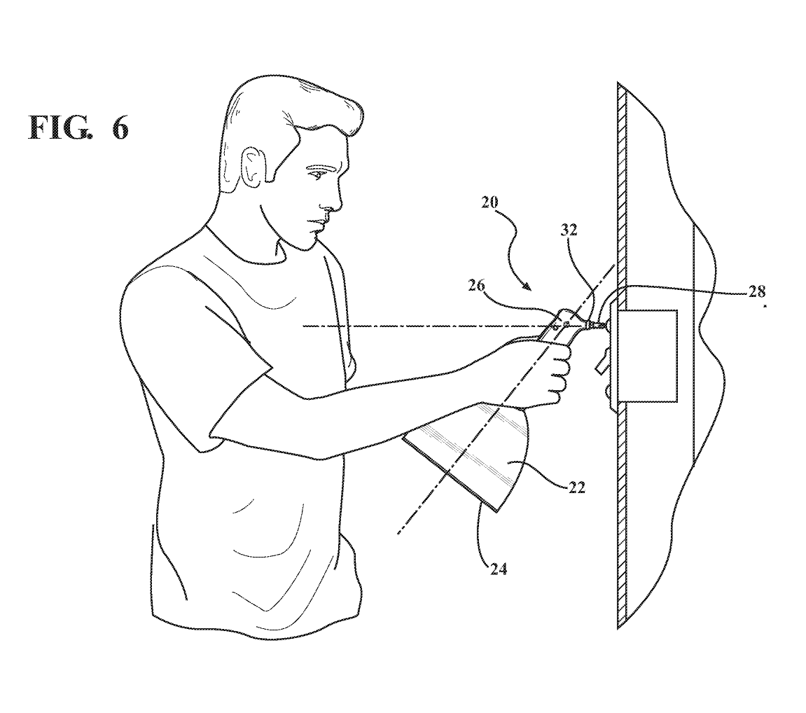

As shown in FIGS. 1 and 2, the blade holder 34 is pivotably connected with the handle 26 such that it may be rotated about a pivot point between an open position (FIG. 1) and a closed position (FIG. 2). The pivoting means could be, for example, a rivet which extends through the blade holder 34 and into the handle 26. As shown in FIGS. 3 and 4, a side wall of the housing presents an opening 36 for allowing the blade holder 34 and the knife blade 30 to exit a pocket within an interior of the housing 26 for use and to enter the interior of the housing 26 for storage. Because the knife blade 30 is fully enclosed within the confines of the housing 26 when the blade holder 34 is in the closed position, a worker is protected from accidentally cutting himself or herself. Preferably, the housing 26 is made of two pieces which are joined together, for example with one or more screws 38, to allow for easy access into the interior of the handle 26 between the two pieces. This allows a worker to easily replace the knife blade 30 in the blade holder 34 when the knife blade 30 becomes worn.

Similar to the Phillips head screwdriver bit 28, when the blade holder 34 is in the open position, the knife blade 30 extends at an angle of between thirty degrees and sixty degrees) (30°-60°) and most preferably at approximately a forty-five degree angle)(45°) angle relative to the handle 26. This angle has been found to allow for easier use of the knife blade 30 while holding the handle 26 by allowing a worker to hold the handle 26 in a vertical orientation while cutting the drywall panels.

The multi-tool assembly 20 also includes at least one locking mechanism for safely and securely locking the utility blade holder 34 into the open position (shown in FIG. 1) and/or the closed position (shown in FIG. 2). In the exemplary embodiment, the locking mechanism includes a pair of buttons 40 which are spaced from the pivot axis of the blade holder 34 by a similar distance and which are biased to engage within a detent or recess in the blade holder 34. Specifically, one of the buttons 40 is positioned to engage within the detent when the blade holder 34 is in the closed position to lock the knife blade 30 in the pocket of the housing 26 and out of harm's way. The other button 40 is positioned to engage within the detent of the blade holder 34 when the blade holder 34 is in the open position such that the knife blade 30 extends at least partially outside of the housing 26 for cutting objects. The buttons 40 may be pulled away from the detent in the blade holder 34 by the worker to allow the worker to rotate the blade holder 34 between the open and closed positions. Preferably, the buttons 40 extend through the front or back of the housing 26 for providing easy access to the buttons 40 for the worker. It should be appreciated that the locking mechanism could take a range of different forms and configurations.

The multi-tool assembly 20 is advantageous because a worker may reorient the single handle 26 in his or her hand to switch between spreading a joint compound with the drywall blade 22, screwing drywall panels with the Phillips head screwdriver bit 28 and cutting openings in the drywall panels with the utility knife blade 30. This is significantly quicker, less clumsy and potentially safer than using separate tools for each of these tasks.

Another aspect of the present invention is related to a method of installing or repairing drywall. The method includes the step of providing a multi-tool assembly 20 which has a single handle 26 that extends in a first direction between opposite ends. A putty blade 22 is secured with one of the ends, and at the other end of the handle 26, the multi-tool assembly 20 includes a screwdriver bit 28 and a blade holder 34 with a utility knife blade 30. The method continues with the step of moving the blade holder 34 from a closed position with the utility knife blade 30 being fully enclosed within the handle 26 to an open position with the utility knife blade 30 extending partially out of the handle 26. The method proceeds with the step of cutting one of the drywall panels with the utility knife blade 30. The method continues with the step of moving the blade holder 34 from the open position to the closed position. The method proceeds with the step of securing one of the drywall panels to a stud with the screwdriver bit 28. The method continues with the step of spreading a joint compound across a joint between adjacent drywall panels with the putty blade 22.

Obviously, many modifications and variations of the present invention are possible in light of the above teachings and may be practiced otherwise than as specifically described while within the scope of the appended claims.

What is claimed is:

1. A multi-tool assembly for use in drywall installation and repair, comprising:
a handle which extends in a first direction between opposite ends and which presents an interior with a pocket;
a putty blade with a flat edge secured with one end of said handle for spreading a drywall joint compound;
a utility knife blade for cutting drywall sheets; and
a blade holder engaging said utility knife blade and being at least partially disposed in said pocket of said handle and movable between a closed position wherein said utility knife blade is fully disposed in said pocket of said interior of said handle and an open wherein said utility knife blade extends at least partially out of said pocket of said interior of said handle.

2. The multi-tool assembly as set forth in claim 1 wherein said blade holder is rotatable about a pivot axis between said open and closed positions.

3. The multi-tool assembly as set forth in claim 2 further including a locking mechanism for locking said blade holder in at least one of said open and closed positions.

4. The multi-tool assembly as set forth in claim 3 wherein said locking mechanism includes at least one button that is releasably engagable with a detent in said blade holder for locking said blade holder in at least one of said open and closed positions.

5. The multi-tool assembly as set forth in claim 4 wherein said locking mechanism includes a pair of buttons that are spaced from said pivot axis with one of said buttons being configured to lock said blade holder in said open position and the other button being configured to lock said blade holder in said closed position.

6. The multi-tool assembly as set forth in claim 1 wherein when said blade holder is in said open position, said knife blade extends at an angle of between thirty and sixty degrees relative to said handle.

7. The multi-tool assembly as set forth in claim 6 wherein when said blade holder is in said open position, said knife blade extends at an angle of approximately forty-five degrees relative to said handle.

8. The multi-tool assembly as set forth in claim 1 wherein said housing has an opening for passing said knife blade into and out of said pocket of said housing.

9. The multi-tool assembly as set forth in claim 1 further including a screwdriver bit secured with said handle adjacent said utility knife blade.

10. The multi-tool assembly as set forth in claim 9 wherein further including a bit holder which is permanently secured with said handle and which releasably receives said screwdriver bit.

11. The multi-tool assembly as set forth in claim 9 wherein said screwdriver bit is a Phillips head screwdriver bit.

12. The multi-tool assembly as set forth 9 wherein said screwdriver bit extends at an angle of between thirty and sixty degrees relative to said handle.

13. The multi-tool assembly as set forth in claim 12 wherein said screwdriver bit extends at an angle of approximately forty-five degrees relative to said handle.

14. A method of installing or repairing drywall, comprising the steps of:
providing a multi-tool assembly including a single handle which extends in a first direction between opposite ends and has a putty blade secured with one end and a blade holder with a utility knife blade secured the other end;
spreading a joint compound between adjacent drywall panels with the putty blade; and
moving the blade holder from a closed position with the utility knife blade being fully disposed within the handle to an open position with the utility knife blade extending partially out of the handle; and
cutting one of the drywall panels with the utility knife blade.

15. The method as set forth in claim 14 further including the step of securing one of the drywall panels to a stud with a screwdriver bit adjacent the utility knife blade.
